(19) United States
(12) Patent Application Publication
(10) Pub. No.: US 2025/0070525 A1
(43) Pub. Date: Feb. 27, 2025

(54) ELECTRICAL CONNECTOR FOR COUPLING CONDUCTORS TO AN ELECTRONIC COMPONENT

(71) Applicant: Molex, LLC, Lisle, IL (US)

(72) Inventors: Victor Zaderej, Oregon, IL (US); Arresh Amleshi, Lisle, IL (US); Mark James Grote, Oakbrook Terrace, IL (US); Alan Han, Aurora, IL (US); Michael Gerald Amaro, Naperville, IL (US)

(21) Appl. No.: 18/727,707

(22) PCT Filed: Mar. 3, 2023
(86) PCT No.: PCT/IB2023/052014

§ 371 Date: Jul. 10, 2024

Related U.S. Application Data
(60) Provisional application No. 63/317,354, filed on Mar. 7, 2022.

(51) Int. Cl. H01R 43/16; H01R 4/2433; H01R 12/62; H01R 12/67; H01R 13/66; H01R 43/20; H01R 43/24

(52) U.S. Cl. CPC H01R 43/16; H01R 4/2433; H01R 12/62; H01R 12/675; H01R 13/665; H01R 43/205; H01R 43/24

(57) ABSTRACT

An electrical connector having insulation displacement connectors and being formed by is formed by an Application Specific Electronics Packaging (“ASEP”) manufacturing process is provided. A method of forming same is also provided. In an embodiment, the electrical connector is coupled to conductors of wires. The electrical connector may be coupled to a housing.

### RELATED APPLICATIONS

This application claims priority to U.S. Provisional Application No. 63/317,354 filed Mar. 7, 2022, which is incorporated herein by reference.

### FIELD OF THE DISCLOSURE

This disclosure relates to an electrical connector, and the method of manufacturing same. More specifically, this disclosure relates to an assembly including an electrical connector formed using an Application Specific Electronics Packaging (“ASEP”) manufacturing process, a plurality of conductors covered by an insulative coverings.

### DESCRIPTION OF RELATED ART

There is a need in the market for sensors that are connected in a linear array using multiple wire communications and power protocols, such as three or four wire communications and power protocols. These sensors can be used to measure temperature, pressure, current, occupancy, acceleration, etc. The electrical connector supporting the sensor is designed to be easily installed into wires with customer definable lengths, have a variety of sensor options, be cost effective, have high strain relief, and be environmentally protected. The same wires should ideally also support different sensors at the same time. This combination of features/requirements has been difficult to achieve using conventional packaging methods and at a low cost.

Application Specific Electronic Packaging (“ASEP”) devices and manufacturing processes have been developed by the Applicant and are useful for the creation of electronics modules. An advantage of the ASEP manufacturing process is that it allows a manufacturer to integrate connector functions into the electronics module that would be much larger and more expensive if the connector functions were discrete components. Furthermore, metal contacts integrated into ASEP devices are highly conductive so the metal contacts provide an optimal path for carrying high current, as well as removing heat very efficiently.

The ASEP manufacturing process utilizes many of the same manufacturing steps used to produce connectors, but adds significantly more functionality with minimal addition of cost. ASEP manufacturing processes have previously been described and illustrated in U.S. Pat. Nos. 10,433,428, 10,667,407, 10,905,014 and 11,503,718, the disclosures of which are incorporated herein by reference.

### BRIEF DESCRIPTION OF THE DRAWINGS

The present disclosure is illustrated by way of example, and not limited, in the accompanying figures in which like reference numerals indicate similar elements and in which:

FIG. 1 depicts a top perspective view of an assembly according to a first embodiment which includes an electrical connector and a plurality of wires;

FIG. 2 depicts a bottom perspective view of the assembly of FIG. 1;

FIG. 3 depicts a top plan view of the assembly of FIG. 1;

FIG. 4 depicts a top plan view of the assembly of FIG. 1 with an overmolded housing;

FIG. 5 depicts a reel-to-reel assembly process for making the electrical connector of FIG. 1;

FIG. 6 depicts a top perspective view of a lead frame used in the reel-to-reel assembly process of FIG. 5 which forms the electrical connector of FIG. 1;

FIG. 7 depicts a bottom perspective view of the lead frame and an insulative substrate used in the reel-to-reel assembly process of FIG. 5 which forms the electrical connector of FIG. 1;

FIG. 8 depicts a bottom plan view of the lead frame and the insulative substrate used in the reel-to-reel assembly process of FIG. 5 which forms the electrical connector of FIG. 1;

FIG. 9 depicts a top perspective view of an assembly according to a second embodiment which includes an electrical connector, a housing and a cap;

FIGS. 10 and 11 depict top perspective views of alternate housings which can be used in the second embodiment;

FIG. 12 depicts a cross-sectional view of the housings of FIGS. 9-11;

FIG. 13 depicts a bottom plan view of a first embodiment of the cap;

FIG. 14 depicts a bottom plan view of a second embodiment of the cap;

FIG. 15 depicts parts of an assembly process for making the electrical connector which is used with the housings and caps of FIGS. 9-14;

FIG. 16 depicts a top perspective view of an assembly according to a third embodiment which includes an electrical connector, a housing and a cap;

FIG. 17 depicts a top perspective view of an assembly according to a fourth embodiment which includes an electrical connector and a housing;

FIG. 18 depicts a cross-sectional view of the housing of FIG. 17; and

FIG. 19 depicts a flow chart illustrating the reel-to-reel assembly process.

### DETAILED DESCRIPTION

While the disclosure may be susceptible to embodiments in different forms, it is shown in the drawings and herein which is described in detail, specific embodiments with the understanding that the present disclosure is to be considered an exemplification of the principles of the disclosure and is not intended to limit the disclosure to that as illustrated and described herein. Therefore, unless otherwise noted, features disclosed herein may be combined to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

Directional terms such as front, rear, horizontal, vertical and the like are used for ease in explanation, and do not denote a required orientation in use.

An insulation-displacement contact (IDC) (also known as an insulation-piercing contact (IPC)), is designed to be connected to the conductor(s) of an insulated wire by a connection process which forces a selectively sharpened blade or blades through the insulation of the wire, bypassing the need to strip the insulation from the conductors before connecting. The present disclosure uses an Application Specific Electronic Packaging (“ASEP”) manufacturing method to create an electrical connector having insulation-displacement contacts that can be adapted to a plurality of sensor technologies. The electrical connector has a surface onto which a laser pattern is scribed and then plated for the desired sensor types. The insulation-displacement contacts are integrated into the electrical connector, thereby enabling the user to compress a wire onto the insulation displacement contacts to create a strong electrical and mechanical interface to the electrical connector. The electrical connector has an insulative housing overmolded to increase durability and provide environmental protection. The unique properties of ASEP allow for the creation of an assembly that has the features of a printed circuit board and the features of an electrical connector, produced in a single, high volume, compact, and low-cost assembly. The end result provides an assembly that can be modified for a variety of applications and customers with minimal additional capital and lead time because the circuit pattern is written with a computer-controlled laser, which can be instantly reprogrammed to write different patterns to support different sensors. The ASEP manufacturing process is disclosed in, for example, U.S. Pat. Nos. 10,433,428, 10,667,407, 10,905,014 and 11,503,718.

In some embodiments, the electrical connector joins two wires which transmit signals to allow sensors to be coupled along the same line. In some embodiments, the electrical connector is coupled to a single wire which transmits signals and reflects the signals back to a controller. While the present disclosure shows individual wires, a flexible printed circuit having a continuous insulative covering with a plurality of conductors therein can instead be provided.

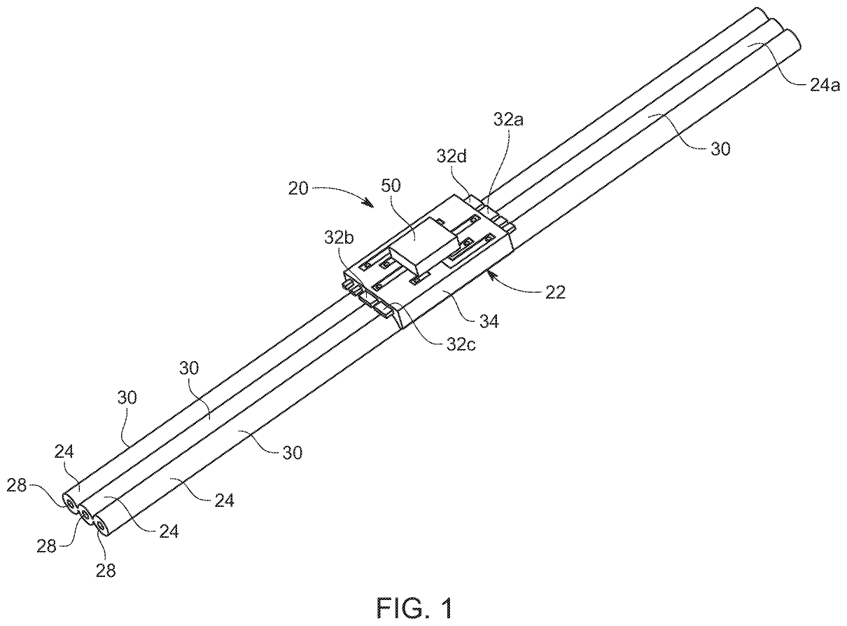

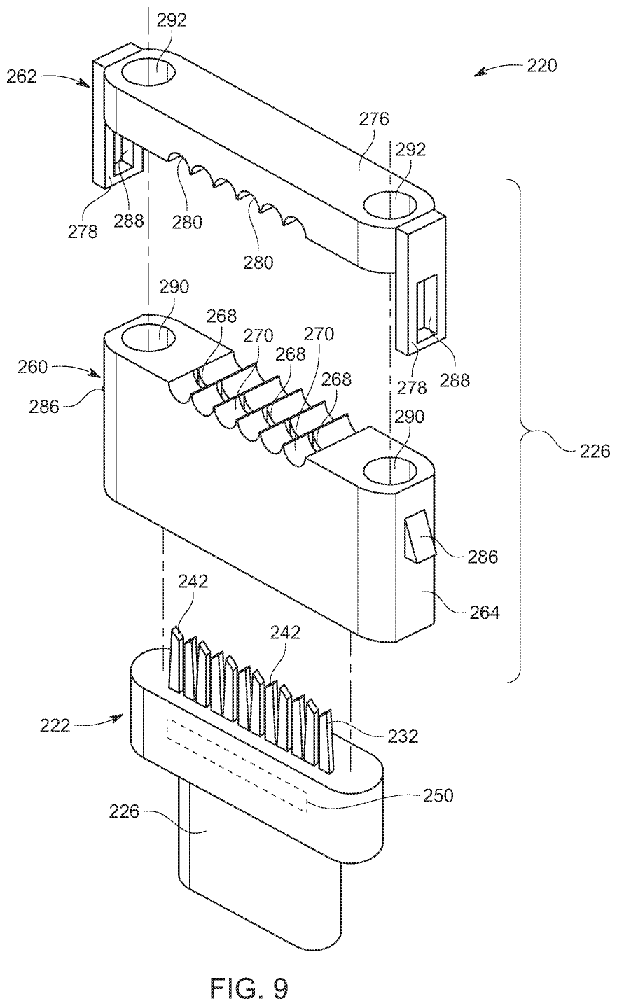

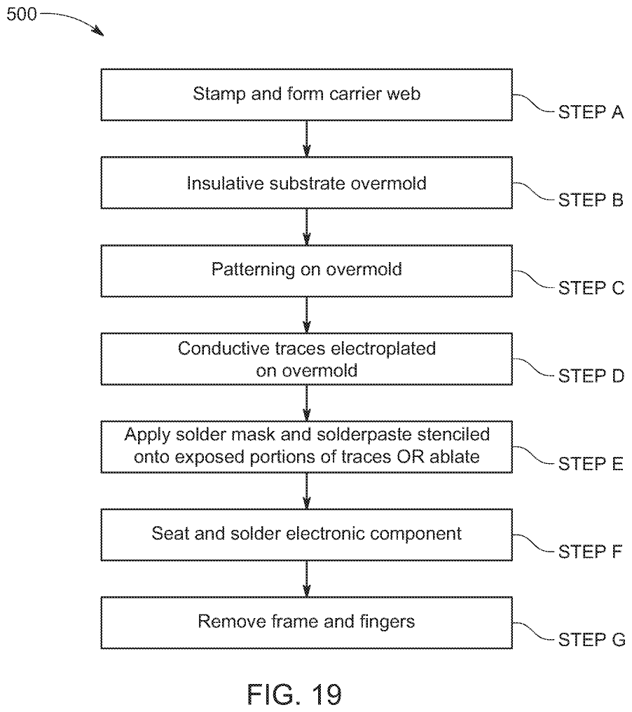

An assembly 20, 220, 320, 420, FIGS. 1, 9, 16 and 17, provides an electrical connector 22, 222 which is formed using an Application Specific Electronics Packaging (“ASEP”) manufacturing process 500, see FIG. 19, and a plurality of wires. In the embodiment shown in FIG. 1, the assembly 20 includes four wires 24a, 24b, 24c, 24d (or a flexible printed circuit can be provided). An insulative housing 26, see FIG. 4, may be provided over the electrical connector 22 of FIG. 1 and over a portion of each wire 24a, 24b, 24c, 24d (or the flexible printed circuit) to increase durability and provide environmental protection. In the embodiments shown in FIGS. 9, 16 and 17, the assembly 220, 320, 420 includes six wires or a flexible printed circuit (not shown). The assembly 220, 320, 420 includes an insulative housing 226, 326, 426 in which the electrical connector 222 is packaged. As few as three wires (or conductors in a flexible printed circuit) can be used with the assembly 20, 220, 320, 420.

The wires 24a, 24b, 24c, 24d are conventional and include conductors (shown as conductor 28 in FIG. 1, the conductor for wire 24a is not shown) surrounded by insulative coverings 30. When a flexible printed circuit is instead provided, the insulative coverings are continuous.

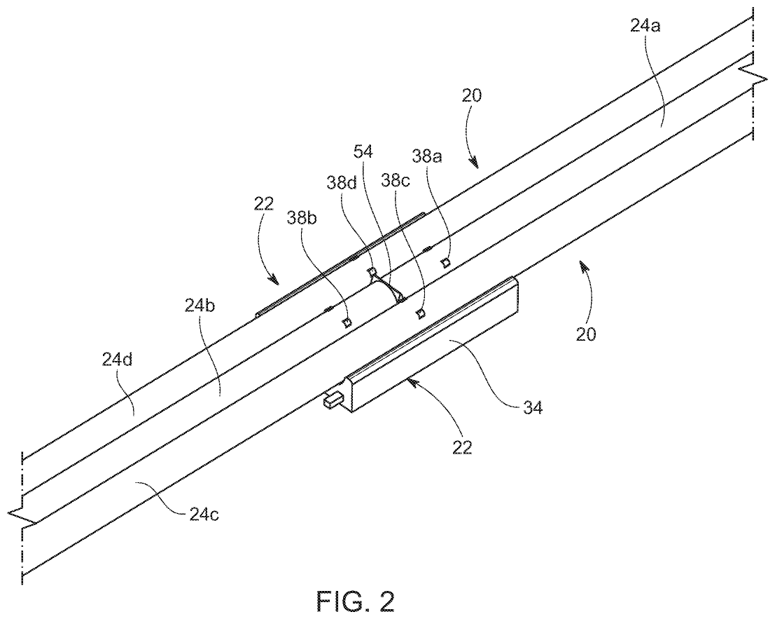

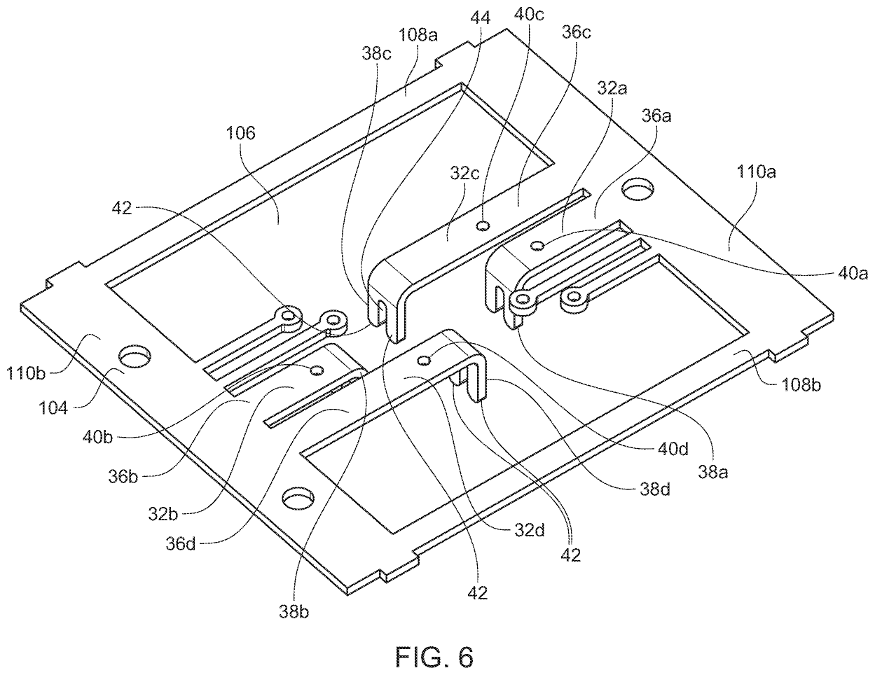

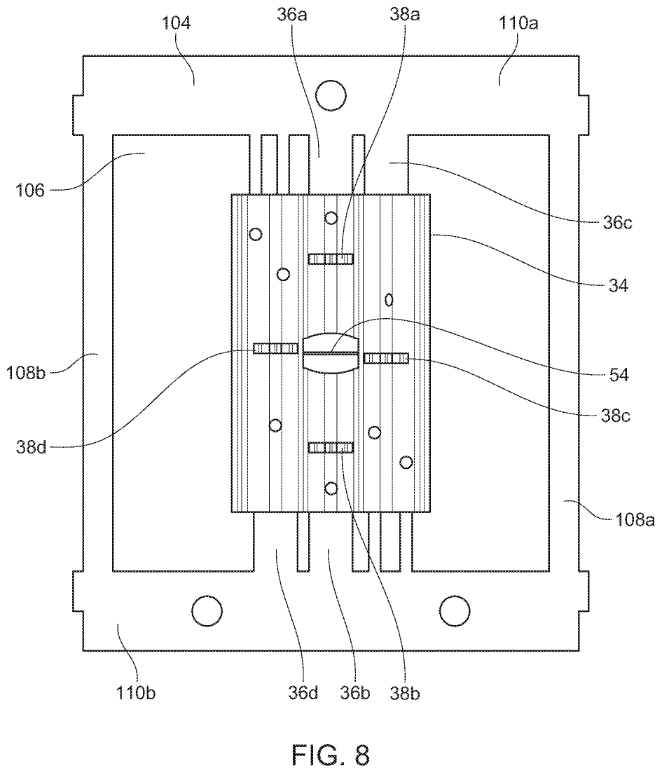

Attention is invited to the embodiment of the electrical connector 22 shown in FIGS. 1-8. As shown, the electrical connector 22 includes first, second, third and fourth conductive insulation displacement connectors 32a, 32b, 32c, 32d within an insulative substrate 34. The substrate 34 has an upper surface and an opposite lower surface, and side surfaces extending therebetween.

In the embodiment as shown, each insulation displacement connector 32a, 32b, 32c, 32d extends in a longitudinal direction of the substrate 34. The first conductive insulation displacement connector 32a is longitudinally aligned with, but spaced from, the second conductive insulation displacement connector 32b. The third conductive insulation displacement connector 32c is offset to a first side of each of the first and second insulation displacement connectors 32a, 32b. The fourth conductive insulation displacement connector 32d is offset to a second side of each of the first and second insulation displacement connectors 32a, 32b.

In the embodiment as shown, each insulation displacement connector 32a, 32b, 32c, 32d is generally L-shaped and has a first section 36a, 36b, 36c, 36d which extends longitudinally along the substrate 34 and a second section 38a, 38b, 38c, 38d which extends at an angle from the first section 36a, 36b, 36c, 36d. The first section 36a, 36b, 36c, 36d of each insulation displacement connector 32a, 32b, 32c, 32d extends from a side surface of the substrate 34 and the second section 38a, 38b, 38c, 38d of each insulation displacement connector 32a, 32b, 32c, 32d extends through the bottom surface of the substrate 34 and outward therefrom. In the embodiment as shown, the first section 36a of the first insulation displacement connector 32a extends from the first side surface of the substrate 34, the first section 36b of the second insulation displacement connector 32b extends from the second side surface of the substrate 34 which is opposite to the first side surface, the first section 36c of the third insulation displacement connector 32c extends from the first side surface of the substrate 34, and the first section 36d of the fourth insulation displacement connector 32d extends from the second side surface of the substrate 34. Each first section 36a, 36b, 36c, 36d may be linear and may be parallel to each other. Each first section 36a, 36b, 36c, 36d may have a through hole 40a, 40b, 40c, 40d extending therethrough. Each second section 38a, 38b, 38c, 38d extends outward from the lower surface of the substrate 34, and has at least one sharp blade 42 (when two blades are provided as shown, the blades are spaced apart from each other by a central slot 44). In the embodiment as shown, each second section 38a, 38b, 38c, 38d is angled at 90 degrees relative to the respective first section 36a, 36b, 36c, 36d.

The insulative substrate 34 has through holes 46a, 46b, 46c, 46d, each of which extends from the top surface of the substrate 34 to the first section 36a, 36b, 36c, 36d of the respective insulation displacement connector 32a, 32b, 32c, 32d. The through holes 46a, 46b, 46c, 46d align with the through holes 40a, 40b, 40c, 40d and are electrically coupled thereto.

A conductive trace 48a, 48b, 48c, 48d extends from the first section 36a, 36b, 36c, 36d of the respective insulation displacement connector 32a, 32b, 32c, 32d. The conductive traces 48a, 48b, 48c, 48d are formed by plating on the wall forming the respective through hole 46a, 46b, 46c, 46d and plating on the upper surface of the insulative substrate 34. The plating forming the conductive trace 48a is mechanically and electrically coupled together, and is mechanically and electrically coupled to the first section 36a of the first conductive insulation displacement connector 32a. The plating forming the conductive trace 48b is mechanically and electrically coupled together, and is mechanically and electrically coupled to the first section 36b of the second conductive insulation displacement connector 32b. The plating forming the conductive trace 48c is mechanically and electrically coupled together, and is mechanically and electrically coupled to the first section 36c of the third conductive insulation displacement connector 32c. The plating forming the conductive trace 48d is mechanically and electrically coupled together, and is mechanically and electrically coupled to the first section 36d of the fourth conductive insulation displacement connector 32d. The traces 48a, 48b, 48c, 48d are electrically isolated from each other by the insulative substrate 34.

An electrical component 50 is mechanically and electrically coupled to the portions of the respective conductive traces 48a, 48b, 48c, 48d on the upper surface of the insulative substrate 34, and may be coupled thereto by soldering. The electrical component 50 may be, but is not limited to, a sensor such as a sensor used to measure used to measure temperature, pressure, current, occupancy, acceleration, etc., a microprocessor unit (MPU)/micro controller unit (MCU), a light emitting diode and/or a speaker. Therefore, a first electrical path is formed by the first insulation displacement connector 32a, the trace 48a, and the electrical component 50, a second electrical path is formed by the second insulation displacement connector 32b, the trace 48b, and the electrical component 50, a third electrical path is formed by the third insulation displacement connector 32c, the trace 48c, and the electrical component 50, and a fourth electrical path is formed by the fourth insulation displacement connector 32d, the trace 48d, and the electrical component 50.

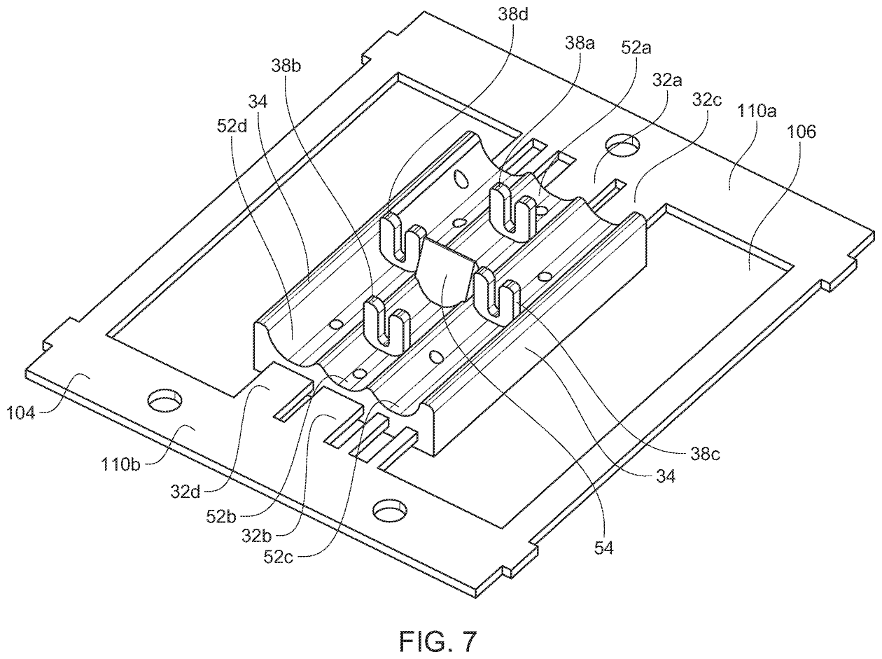

The lower surface of the substrate 34 may have a plurality of longitudinally extending channels 52a, 52b, 52c, 52d, see FIG. 7, that may be partially cylindrical to mirror the shape of an upper portion of the wires 24a, 24b, 24c, 24d. The second section 38a of the first insulation displacement connector 32a extends into the channel 52a, the second section 38b of the second insulation displacement connector 32b extends into the channel 52b, the second section 38c of the third insulation displacement connector 32c extends into the channel 52c, and the second section 38d of the fourth insulation displacement connector 32d extends into the channel 52d. In an embodiment, the substrate 34 has a projection 54 that separates the channels 52a, 52b from each other.

The electrical connector 22 is coupled to the wires 24a, 24b, 24c, 24d by compressing the wire 24a into the channel 52a such that the blade(s) 42 of the first insulation displacement connector 32a bites into the insulative covering 30 of the wire 24a and electrically connects to the conductor 28 thereof, compressing the wire 24b into the channel 52b such that the blade(s) 42 of the second insulation displacement connector 32b bites into the insulative covering 30 of the wire 24b and electrically connects to the conductor 28 thereof, compressing the wire 24c into the channel 52c such that the blade(s) 42 of the third insulation displacement connector 32c bites into the insulative covering 30 of the wire 24c and electrically connects to the conductor 28 thereof, and compressing the wire 24d into the channel 52d such that the blade(s) 42 of the fourth insulation displacement connector 32d bites into the insulative covering 30 of the wire 24d and electrically connects to the conductor 28 thereof. As an alternative, the projection 54 severs a single wire into the two wires 24a, 24b when the single wire is compressed thereagainst, and thereafter the wire 24a is compressed in the channel 52a such that the first insulation displacement connector 32a bites into the insulative covering of the wire 24a and electrically connects to the conductor 28 thereof and then the wire 24b is compressed in the channel 52b such that the second insulation displacement connector 32b bites into the insulative covering of the wire 24b and electrically connects to the conductor 28 thereof. As another alternative, an opening is formed in a single wire to completely sever the conductor and form the separate wires 24a, 24b (although they may still be connected by a common insulative covering), and thereafter the wire 24a is compressed in the channel 52a such that the first insulation displacement connector 32a bites into the insulative covering 30 of the wire 24a and electrically connects to the conductor 28 thereof and then the wire 24b is compressed in the channel 52b such that the second insulation displacement connector 32b bites into the insulative covering 30 of the wire 24b and electrically connects to the conductor 28 thereof.

In an embodiment, after the wires 24a, 24b, 24c, 24d are electrically coupled to the insulation displacement connectors 32a, 32b, 32c, 32d, the housing 26 is formed over the electrical connector 22 and over portions of the wires 24a, 24b, 24c, 24d. The housing 26 may be formed by overmolding. This encapsulates the electrical connector 22 and the portions of the conductive insulation displacement connectors 32a, 32b, 32c, 32d that are exposed from within the electrical connector 22.

The wire 24c may provide power to the electrical component 50, the wire 24d may provide ground to the electrical component 50, and the wires 24a, 24b allow signals to pass through the electrical component 50 and onto the next electrical connector (not shown). In an embodiment, wire 24b is eliminated and signals are reflected back along wire 24a to a controller (not shown).

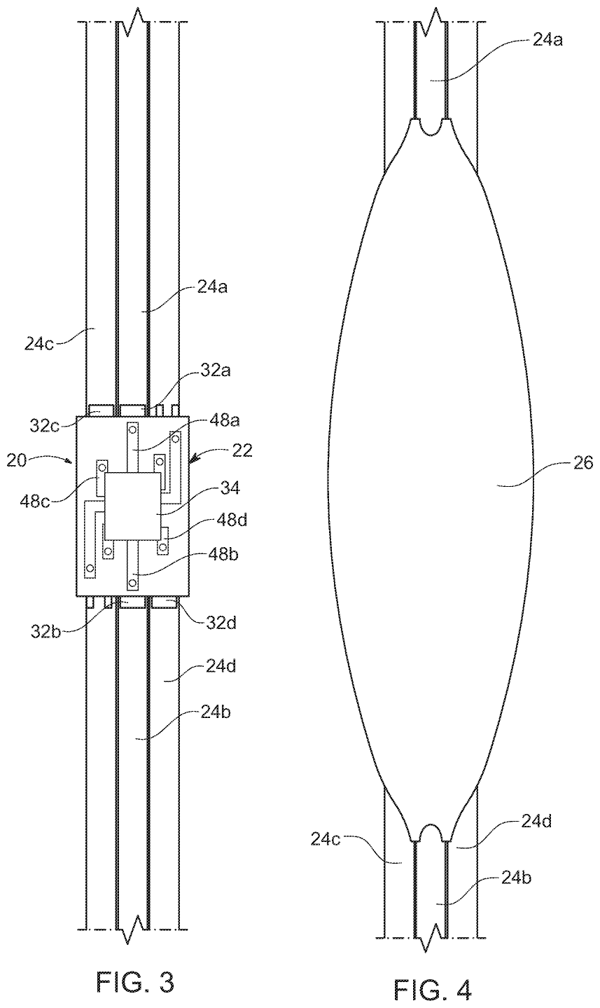

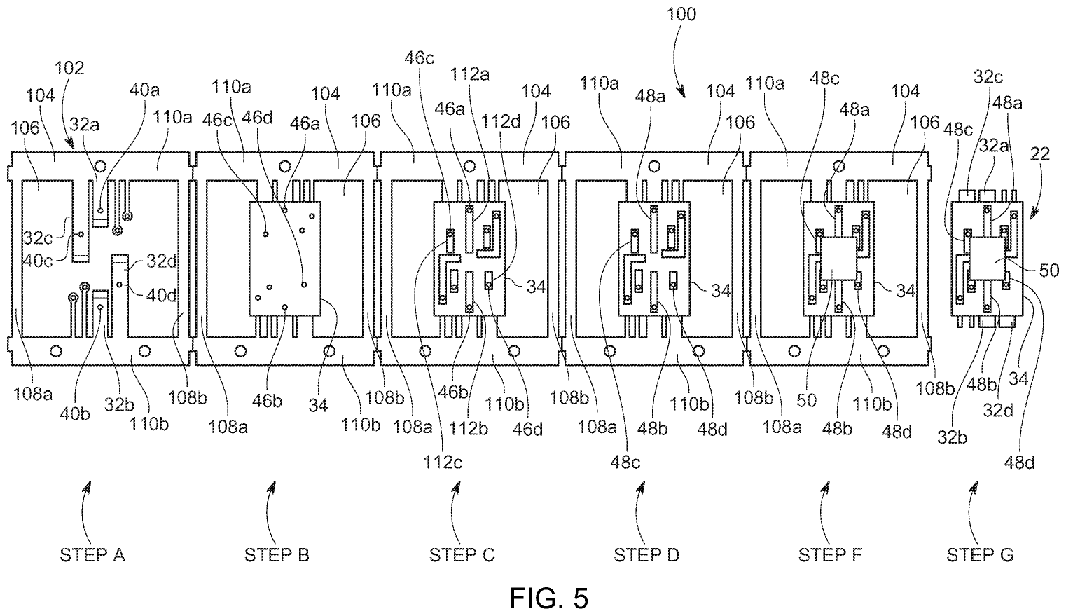

The electrical connector 22 is preferably manufactured using the ASEP manufacturing process. Attention is invited to FIG. 5 which illustrates the formation of the electrical connector 22, and additionally to FIGS. 3 and 4. FIG. 19 provides a flow chart showing steps of the ASEP manufacturing process 500.

As illustrated in FIGS. 5 and 19, the ASEP manufacturing process 500 begins with Step A. ASEP manufacturing process 500 preferably occurs between a pair of reels (not shown). In Step A, a middle portion of a continuous carrier web 102 is stamped and formed (thus removing undesired portions of the middle portion of the carrier web 102) to form a lead frame 104 with an opening 106 and to form the insulation displacement connectors 32a, 32b, 32c, 32d which extend inwardly into the opening 106. The lead frame 104 is formed in a desired configuration suited for the formation of the electrical connector 22. The lead frame 104 preferably includes end portions 108a, 108b (it being understood that the end portions 108a, 108b of one lead frame 104 are continuous with the end portions 108a, 108b of the adjacent lead frame 104), and a pair of stabilizing portions 110a, 110b (it being understood that stabilizing portions 110a, 110b of one lead frame 104 will also preferably act as stabilizing portions 110b, 110b of the adjacent lead frame 104), with each stabilizing portion 110a, 110b spanning the distance between the opposite end portions 108a, 108b. The opposite end portions 108a, 108b and the stabilizing portions 110a, 110b thus generally form a rectangular frame which defines the opening 106 therebetween. The insulation displacement connectors 32a, 32b, 32c, 32d are connected to one of the stabilizing portions 110a, 110b.

The ASEP manufacturing process 500 continues with Step B. In Step B, the substrate 34 is overmolded to the insulation displacement connectors 32a, 32b, 32c, 32d. The through holes 46a, 46b, 46c, 46d of the substrate 34 align with the through holes 40a, 40b, 40c, 40d of the insulation displacement connectors 32a, 32b, 32c, 32d to expose portions of the first sections 36a, 36b, 36c, 36d. The substrate 34 may be formed of Acrylonitrile butadiene styrene (ABS), Polyphenylene sulfide (PPS), Syndiotactic Polystyrene (SPS), poly carbonate, poly carbonate blends, polypropylene, polypropylene blends. The substrate 34 may also advantageously be formed with a thermally conductive liquid crystal polymer (LCP). By making the substrate 34 out of thermally conductive LCPs, the heat loads of the electronics can be significantly reduced in the electrical connector 22. End portions of the insulation displacement connectors 32a, 32b, 32c, 32d do not have the substrate 34 overmolded thereto. The overmolding of Step B can be performed with single or two shot processes, or any other conventional molding process.

The ASEP manufacturing process 500 continues with Step C. In Step C, patterning is performed on the substrate 34. The patterning provides for one or more patterns 112a, 112b, 112c, 112d (which may be circuit patterns) to be formed on the upper surface of the substrate 34 and in the holes 46a, 46b, 46c, 46d. The patterns 112a, 112b, 112c, 112d can be formed by any number of suitable processes, including a laser process, a plasma process (which can be a vacuum or atmospheric process), a UV process and/or a fluorination process. Depending on the process used (e.g., plasma, UV and/or fluorination), the patterning may comprise patterning (i.e., a surface treatment of) most, if not all, of the upper surface of the substrate 34. Thus, the patterns 112a, 112b, 112c, 112d may be formed on all or nearly all of the upper surface of the substrate 34.

The ASEP manufacturing process 500 continues with Step D. In Step D, the patterns 112a, 112b, 112c, 112d are electroplated by applying a voltage potential to the lead frame 104 (which is electrically connected to the patterns 112a, 112b, 112c, 112d by the insulation displacement connectors 32a, 32b, 32c, 32d and then exposing the lead frame 104, the substrate 34 and the patterns 112a, 112b, 112c, 112d to an electroplating bath). The electroplating process not only electroplates the patterns 112a, 112b, 112c, 112d and the walls forming the through holes 46a, 46b, 46c, 46d, but also electroplates the lead frame 104 and the portions of the insulation displacement connectors 32a, 32b, 32c, 32d that are not covered by the substrate 34. A slug may be formed within the through holes 46a, 46b, 46c, 46d and through holes 40a, 40b, 40c, 40d in the electroplating process. Step D can involve a single step plating process which builds up a single layer of a single material, such as copper, or can involve a multistep plating process which builds up multiple layers of multiple materials, such as a copper layer and a tin layer, it being understood that other suitable material could also be used. The increased thickness allows for increased current carrying capability and, in general, the electroplating process tends to create a material that has a high conductivity, such that the performance of the resultant electronic circuit traces 48a, 48b, 48c, 48d is improved.

The ASEP manufacturing process 500 continues with Step E, but FIG. 5 does not illustrate this step (Step E is shown in FIG. 19). In Step E, a solder mask is applied which covers select portions of the electronic circuit traces 48a, 48b, 48c, 48d and all, or substantially all, of the exposed surfaces of the substrate 34 and solder paste is stenciled onto the exposed portions of the electronic circuit traces 48a, 48b, 48c, 48d (namely those portions not covered by the solder mask). Alternatively in Step E, a laser ablates tin that is plated over the nickel in areas around the perimeter of the components. Since tin is highly susceptible to soldering and nickel is not, the solder is prevented from flowing away from the components.

The ASEP manufacturing process 500 continues with Step F. In Step F, the electrical component 50 is electrically connected to the electronic circuit traces 48a, 48b, 48c, 48d on the upper surface of the substrate 34, which preferably occurs via soldering.

The ASEP manufacturing process 500 continues with Step G. In Step G, the lead frame 104 and the portions of the insulation displacement connectors 32a, 32b, 32c, 32d outside of the substrate 34 are punched/removed. The electrical connector 22 is thereby formed.

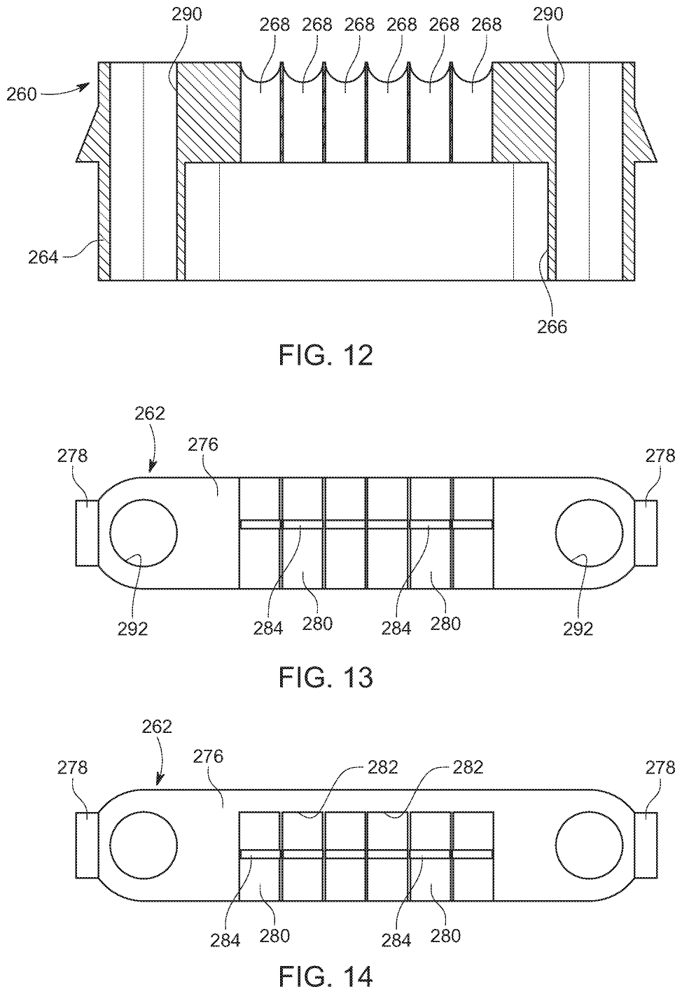

Attention is invited to the embodiment of the electrical connector 222 shown in FIGS. 9-15. As shown, the electrical connector 222 includes six insulation displacement connectors 232 within an insulative substrate 234, all of which are within an insulative housing 226. While six insulation displacement connectors 232 are shown, at least three insulation displacement connectors are provided. The substrate 234 has an upper surface and an opposite lower surface, and side surfaces extending therebetween.

In the embodiment as shown, each insulation displacement connector 232 extends in a longitudinal direction of the substrate 234. The insulation displacement connectors 232 are parallel to each other, and are spaced apart from each other. Each insulation displacement connector 232 is formed by a linear first section 236 which extends longitudinally from the lower surface of the substrate 234 and a second section 242 formed of at least one sharp blade (shown as two blades which are spaced apart from each other by a central slot) extending linearly from the linear first section 236 and outward from the upper surface of the substrate 234. Each first section 236 may have a through hole 240 extending therethrough.

The insulative substrate 234 has plated through holes 246, each of which extends from a side surface of the substrate 234 to the first section 236 of the respective insulation displacement connector 232. The through holes 246 align with the through holes 240 and are electrically coupled thereto.

A conductive trace 248 extends from the first section 236 of the respective insulation displacement connector 232. The conductive traces 248 are formed by plating on the wall forming the respective through hole 246 and plating on the upper surface of the insulative substrate 234. The plating forming each respective trace 248 is mechanically and electrically coupled together and is mechanically and electrically coupled to the first section 236 of the respective conductive insulation displacement connector 232. The traces 248 are electrically isolated from each other by the insulative substrate 234.

An electrical component 250 is mechanically and electrically coupled to the portions of the respective conductive traces 248 on the upper surface of the insulative substrate 234, and may be coupled thereto by soldering. The electrical component 250 may be, but is not limited to, a sensor such as a sensor used to measure used to measure temperature, pressure, current, occupancy, acceleration, etc., a microprocessor unit (MPU)/micro controller unit (MCU), a light emitting diode and/or a speaker, a microprocessor unit (MPU)/micro controller unit (MCU), a light emitting diode and/or a speaker. Therefore, individual electrical paths are formed by the respective insulation displacement connectors 232, the traces 248, and the electrical component 250.

The insulative housing 226 encapsulates the substrate 234, any exposed portions of the first sections 236, the conductive traces 248 and the electrical component 250. The second sections 242 extend outward from the insulative housing 226.

The insulative housing 226 of the assembly 220 includes an insulative base 260 in to which the electrical connector 222 is attached, and an insulative cap 262 which couples to the base 260.

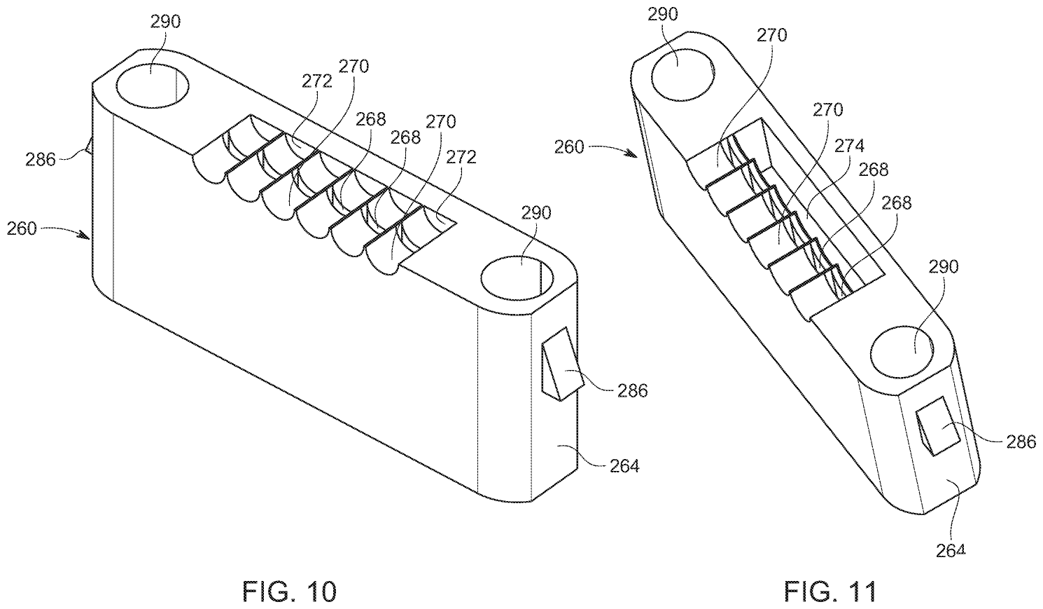

The base 260 has a body 264 having an upper surface and an opposite lower surface, and side surfaces extending therebetween. A pocket 266 extends from the lower surface of the body 264 and is shaped to conform to the housing 226. A plurality of slots 268 extend from the pocket 266 through the upper surface of the body 264. The slots 268 are spaced apart from each other by the body 264 such that insulative material is provided between the slots 268. The slots 268 conform in shape to the second sections 242. The upper surface of the body 264 may have a plurality of longitudinally extending channels 270 which may be partially cylindrical to mirror the shape of a lower portion of a cylindrical wire. The slots 268 extend transversely to the respective channel 270 and intersect the respective channels 270. As shown in FIG. 9, the channels 270 extend from a first side of the body 264 to the opposite second side of the body 264. As shown in FIGS. 10 and 11, the channels 270 only extend along a portion of the body 264. In the embodiment shown in FIG. 10, each channel 270 extends from the first side of the body 264 toward the opposite second side of the body 264 and an upright wall 272 provides a stop surface for the wire(s) to bear against. In the embodiment shown in FIG. 11, each channel 270 extends from the first side of the body 264 toward the opposite second side of the body 264 and a vertical passageway 274 is provided between the slots 268 and the second side of the body 264. The vertical passageway 274 is separated from the slots 268 by the body 264. The vertical passageway 274 may be open to the pocket 266 or may be separated from the pocket 266 by a wall. The vertical passageway 274 provides a location into which the wire(s) can be bent.

The cap 262 has a body 276 having an upper surface and an opposite lower surface, and side surfaces extending therebetween. In an embodiment, a pair of ears 278 extend downward from opposite side surfaces of the body 276. The body 276 is sized to conform to the upper surface of the body 264 of the base 260. The lower surface of the body 264 may have a plurality of longitudinally extending channels 280 which may be partially cylindrical to mirror the shape of an upper portion of a cylindrical wire. As shown in FIG. 13, the channels 280 extend from a first side of the body 276 to the opposite second side of the body 276. As shown in FIG. 14, each channel 280 extends from the first side of the body 276 toward the opposite second side of the body 276 and an upright wall 282 provides a stop surface for the wire(s) to bear against. Each channel 280 may have a slot 284 which extends transversely to the channel 280.

The base 260 and the cap 262 have cooperating locking features to couple base 260 and the cap 262 together. In the embodiments as shown, the ears 278 position against opposite sides of the base 260, and the base 260 has barbs 286 on the opposite sides which interengage with and snap fit within slots 288 in the ears 278. In addition (or as an alternative), a fastener (not shown) can be passed through aligned holes 290, 292 in the base 260 and the cap 262.

To mate the electrical connector 222 with the base 260, the second sections 242 are inserted into the pocket 266 and then into individual slots 268. In the embodiment as shown, the housing 226 seats within the pocket 266 and the second sections 242 extend upward from the slots 268 and the channels 270. In another embodiment, the pocket 266 is eliminated and only the slots 268 are provided into which the second sections 242 are seated and extend upwardly from. The upper end of the housing 226 sits flush against the bottom surface of the body 264.

To couple the wires or the flexible printed circuit to the electrical connector 222 which is attached to the base 260, each wire or the flexible printed circuit is compressed into the respective channel 270 such that the second section 242 of the respective insulation displacement connector 232 bites into the insulative covering of the wire and electrically connects to the conductor thereof. The cap 262 is then pressed onto the base 260 and the wires and the wires seat within the channels 280 of the cap 262. The channels 280 of the cap 262 align with the channels 270 of the base 260, and the slots 284 of the cap 262 align with the slots 268 of the base 260 such the second sections 242 seat within the slots 284 of the cap 262. The base 260 and the cap 262 mate together by the cooperating locking features.

Alternatively, the wire or the flexible printed circuit is first compressed into the respective channel 270 in the base 260, and the cap 262 is then pressed onto the base 260 and mated therewith by the cooperating locking features. Thereafter, the electrical connector 222 is attached to the base 260 as described hereinabove. Once the second section 242 of the respective insulation displacement connector 232 passes through the slots 268 of the base 260, the second section 242 of the respective insulation displacement connector 232 bites into the insulative covering of the respective wire and electrically connects to the conductor thereof.

Once conductor may provide power to the electrical component 250, another conductor may provide ground to the electrical component 250, and other conductor(s) allow signals to pass through the electrical component 250 and onto the next electrical connector (not shown) or allow signals to be reflected to a controller (not shown).

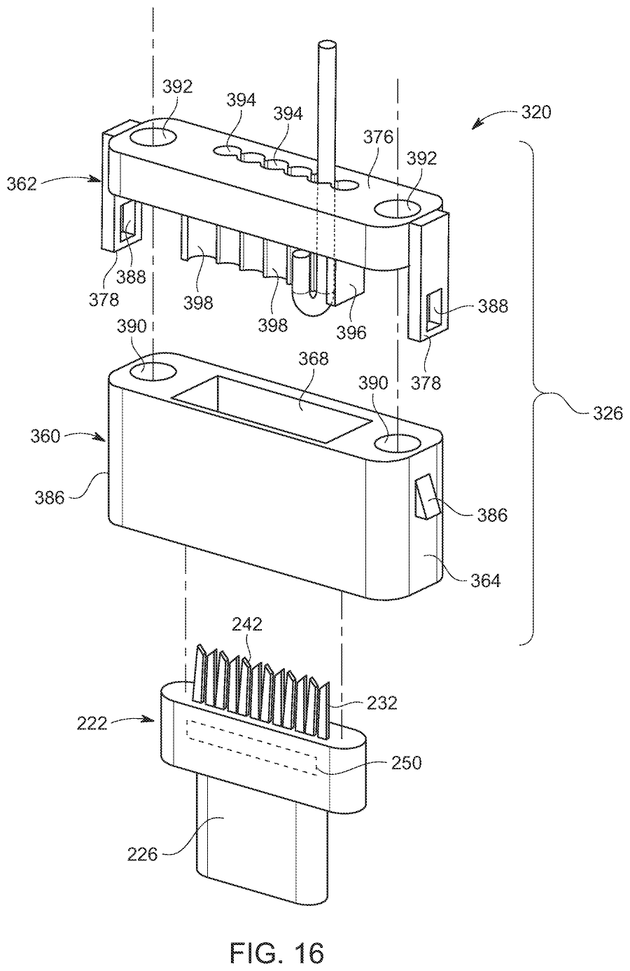

FIG. 16 shows the assembly 320 which incorporates the electrical connector 222 of FIGS. 9-15. The insulative housing 326 of the assembly 320 includes an insulative base 360 in which the electrical connector 222 is housed, and an insulative cap 362 which couples to the base 360.

The base 360 has a body 364 having an upper surface and an opposite lower surface, and side surfaces extending therebetween. A pocket (not shown) extends from the lower surface of the body 364 and is shaped to conform to the housing 326. An elongated slot 368 extends from the pocket through the upper surface of the body 364.

The cap 362 has a body 376 having an upper surface and an opposite lower surface, and side surfaces extending therebetween. In an embodiment, a pair of ears 378 extends downward from opposite side surfaces of the body 376. The body 376 is sized to conform to the upper surface of the body 364 of the base 360. The body 376 has plurality of channels 394 which extend from the upper surface to the lower surface. A projecting wall 396 extends from the lower surface of the body 376 and is sized to seat within the slot 368. The projecting wall 396 has a plurality of spaced apart vertically extending channels 398, each of which aligns with one of the channels 394. The channels 398 are spaced apart from each other by the body 376 such that insulative material is provided between the channels 398. The channels 394 may be partially cylindrical to mirror the shape of a portion of a cylindrical wire.

The base 360 and the cap 362 have cooperating locking features to couple base 360 and the cap 362 together. In the embodiments as shown, the ears 378 position against opposite sides of the base 360, and the base 360 has barbs 386 on the opposite sides which interengage with and snap fit within slots 388 in the ears 378. In addition (or as an alternative), a fastener (not shown) can be passed through aligned holes 390, 392 in the base 360 and the cap 362.

To mate the electrical connector 222 with the base 360, the second sections 242 are inserted into the slot 368. In the embodiment as shown, a portion of the housing 226 and the second sections 242 seat within the slot 368. In another embodiment, only the second sections 242 seat within the slot 368 and the upper end of the housing 226 sits flush against the bottom surface of the body 364.

To couple the wires or the flexible printed circuit to the electrical connector 222 which is attached to the base 360, each wire or the flexible printed circuit is passed through a respective channel 394 and into a respective channel 398. The end of the wire or the flexible printed circuit is bent upward to engage against the lower surface of the body 376. The projecting wall 396 having the wires or the flexible printed circuit mounted therein is pushed into the slot 368 and the second section 242 of the respective insulation displacement connector 232 bites into the insulative covering of the wire and electrically connects to the conductor thereof. The base 360 and the cap 362 mate together by the cooperating locking features. The 222

Alternatively, the projecting wall 396 having the wires or the flexible printed circuit mounted therein is first pushed into the slot 368, and the cap 362 is mated with the base 360 by the cooperating locking features. Thereafter, the electrical connector 222 is attached to the base 360 as described hereinabove, and the second section 242 of the respective insulation displacement connector 232 bites into the insulative covering of the wire and electrically connects to the conductor thereof.

Once conductor may provide power to the electrical component 250, another conductor may provide ground to the electrical component 250, and other conductor(s) allow signals to pass through the electrical component 250 and onto the next electrical connector (not shown) or allow signals to be reflected to a controller (not shown).

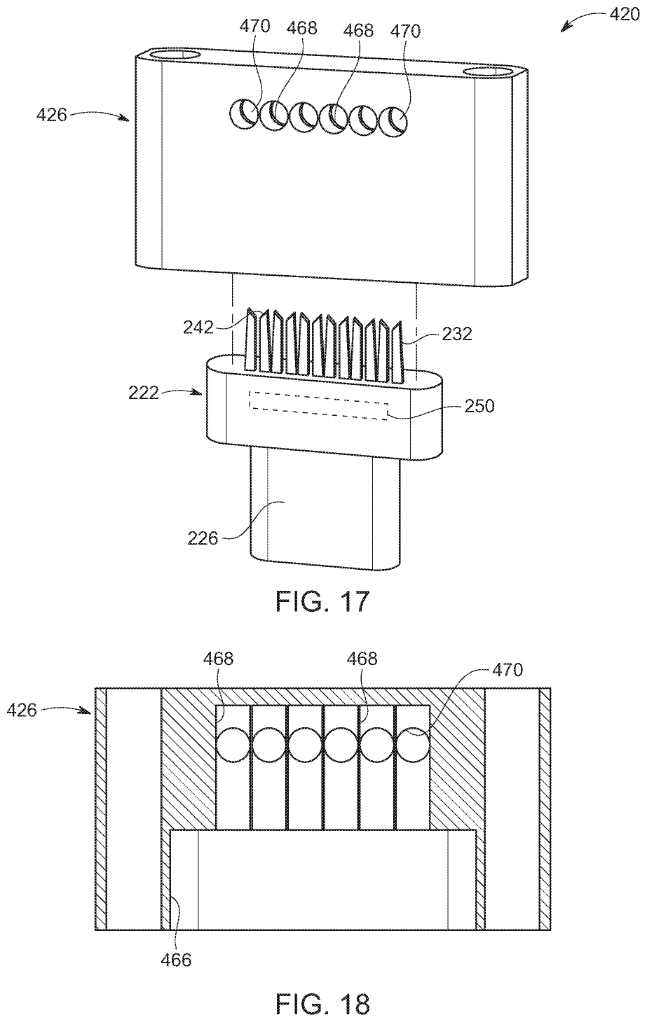

FIGS. 17 and 18 show the assembly 420 which incorporates the electrical connector 222 of FIGS. 9-16. The insulative housing 426 of the assembly 420 has an upper surface and an opposite lower surface, and side surfaces extending therebetween. A pocket 466 extends from the lower surface of the housing 426 and is shaped to conform to the housing 226. A plurality of slots 468 extend from the pocket 466 toward the upper surface of the housing 426. The slots 468 are spaced apart from each other by the body 464 such that insulative material is provided between the slots 468. The slots 468 conform in shape to the second sections 242. The housing 426 has a plurality of longitudinally extending openings 470 which may be cylindrical to mirror the shape of a lower portion of a cylindrical wire. The slots 468 extend transversely to the respective openings 470 and intersect the respective openings 470. As shown in FIG. 17, the openings 470 extend from a first side of the housing 426 to the opposite second side of the housing 426.

To couple the wire or the flexible printed circuit to the assembly 20, the wire or the flexible printed circuit is first passed through the respective opening 470 in the body 464. Thereafter, the electrical connector 222 is attached to the body 464. To mate the electrical connector 222 with the body 464, the second sections 242 are inserted into the pocket 466 and then into individual slots 468. Once the second section 242 of the respective insulation displacement connector 232 passes into the respective channel 270, the second section 242 of the respective insulation displacement connector 232 bites into the insulative covering of the wire and electrically connects to the conductor thereof. In another embodiment, the pocket 466 is eliminated and only the slots 468 are provided into which the second sections 242 are seated and extend upwardly from. The upper end of the housing 226 sits flush against the bottom surface of the body 464.

The electrical connector 222 is preferably manufactured using the ASEP manufacturing process. Attention is invited to FIG. 19, which illustrates the formation of the electrical connector 222. FIG. 19 provides a flow chart showing steps of the ASEP manufacturing process 500.

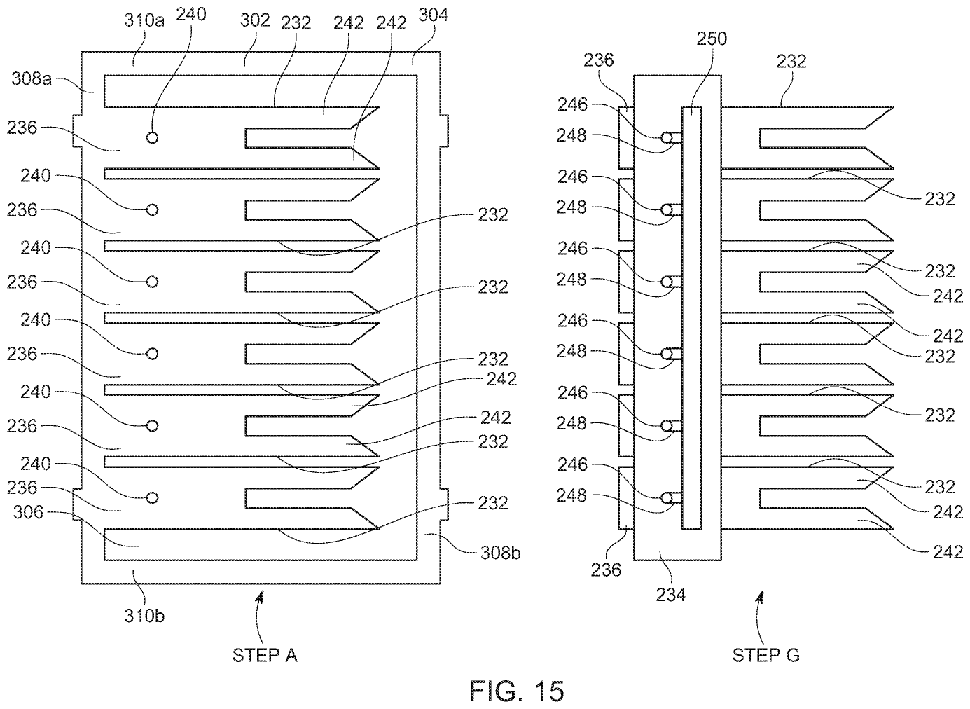

As illustrated in FIGS. 15 and 19, the ASEP manufacturing process 500 begins with Step A. ASEP manufacturing process 500 preferably occurs between a pair of reels (not shown). In Step A, a middle portion of a continuous carrier web (not shown) is stamped and formed (thus removing undesired portions of the middle portion of the carrier web) to form a lead frame 304 with an opening 306 and to form the insulation displacement connectors 232 which extend inwardly into the opening 306. The lead frame 304 is formed in a desired configuration suited for the formation of the electrical connector 222. The lead frame 304 preferably includes end portions 308a, 308b (it being understood that the end portions 308a, 308b of one lead frame 304 are continuous with the end portions 308a, 308b of the adjacent lead frame 304), and a pair of stabilizing portions 310a, 310b (it being understood that stabilizing portion 310a of one lead frame 304 will also preferably act as stabilizing portion 310b of the adjacent lead frame 304), with each stabilizing portion 310a, 310b spanning the distance between the opposite end portions 308a, 308b. The opposite end portions 308a, 308b and the stabilizing portions 310a, 310b thus generally form a rectangular frame which defines the opening 306 therebetween. The insulation displacement connectors 232 are connected to one of the stabilizing portions 310a, 310b.

The ASEP manufacturing process 500 continues with Step B, which is not shown in FIG. 15. In Step B, the substrate 234 is overmolded to the insulation displacement connectors 232. The through holes 246 of the substrate 234 align with the through holes 240 of the insulation displacement connectors 232 to expose portions of the first sections 236. The substrate 234 may be formed of Acrylonitrile butadiene styrene (ABS), Polyphenylene sulfide (PPS), Syndiotactic Polystyrene (SPS), poly carbonate, poly carbonate blends, polypropylene, polypropylene blends. The substrate 234 may also advantageously be formed with a thermally conductive liquid crystal polymer (LCP). By making the substrate 234 out of thermally conductive LCPs, the heat loads of the electronics can be significantly reduced in the electrical connector 222. End portions of the insulation displacement connectors 232 do not have the substrate 234 overmolded thereto. The overmolding of Step B can be performed with single or two shot processes, or any other conventional molding process.

The ASEP manufacturing process 500 continues with Step C which is not shown in FIG. 15. In Step C, patterning is performed on the substrate 234. The patterning provides for one or more patterns (which may be circuit patterns) to be formed on the side surface of the substrate 234 and in the holes 246. The patterns can be formed by any number of suitable processes, including a laser process, a plasma process (which can be a vacuum or atmospheric process), a UV process and/or a fluorination process. Depending on the process used (e.g., plasma, UV and/or fluorination), the patterning may comprise patterning (i.e., a surface treatment of) most, if not all, of the side surface of the substrate 234. Thus, the patterns may be formed on all or nearly all of the side surface of the substrate 234.

The ASEP manufacturing process 500 continues with Step D which is not shown in FIG. 15. In Step D, the patterns are electroplated by applying a voltage potential to the lead frame 304 (which is electrically connected to the patterns by the insulation displacement connectors 232 and then exposing the lead frame 304, the substrate 234 and the patterns to an electroplating bath). The electroplating process not only electroplates the patterns and the walls forming the through holes 246, but also electroplates the lead frame 304 and the portions of the insulation displacement connectors 232 that are not covered by the substrate 234. A slug may be formed within the through holes 246 and through holes 240 in the electroplating process. Step D can involve a single step plating process which builds up a single layer of a single material, such as copper, or can involve a multistep plating process which builds up multiple layers of multiple materials, such as a copper layer and a tin layer, it being understood that other suitable material could also be used. The increased thickness allows for increased current carrying capability and, in general, the electroplating process tends to create a material that has a high conductivity, such that the performance of the resultant electronic circuit traces 248 is improved.

The ASEP manufacturing process 500 continues with Step E which is not shown in FIG. 15. In Step E, a solder mask is applied which covers select portions of the electronic circuit traces 248 and all, or substantially all, of the exposed surfaces of the substrate 234 and solder paste is stenciled onto the exposed portions of the electronic circuit traces 248 (namely those portions not covered by the solder mask). Alternatively in Step E, a laser ablates tin that is plated over the nickel in areas around the perimeter of the components. Since tin is highly susceptible to soldering and nickel is not, the solder is prevented from flowing away from the components.

The ASEP manufacturing process 500 continues with Step F which is not shown in FIG. 15. In Step F, the electrical component 250 is electrically connected to the electronic circuit traces 248 on the upper surface of the substrate 234, which preferably occurs via soldering.

The ASEP manufacturing process 500 continues with Step G which is shown in FIG. 15. In Step G, the lead frame 304 and the portions of the insulation displacement connectors 232 outside of the substrate 234 are punched/removed. The electrical connector 222 is thereby formed.

It is to be appreciated that in certain applications not all of Steps A-G (with reference to both the electrical connector 22 and the electrical connector 222) will be needed. It is to be further appreciated that in certain applications the order of Steps A-G may be modified as appropriate.

While the embodiments above are shown with a plurality of insulation displacement connectors, some embodiments may have a single insulation displacement connector where the at least one blade of the single insulation displacement connector is coupled to the wire as described herein, and the opposite end of the single insulation displacement connector is electrically and mechanically coupled to another electrical component such as a sensor, a microprocessor, a flexible printed circuit, a printed circuit board or a bus bar.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All processes described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. As can be appreciated from the various embodiments depicted herein, different features of different embodiments depicted herein can be combined together to form additional combinations. As a result, the embodiments depicted herein are particularly suitable to provide a wide range of configurations that were not all depicted individually so as to avoid repetitiveness and unnecessary duplication.

The disclosure provided herein describes features in terms of preferred and exemplary embodiments thereof. Numerous other embodiments, modifications and variations within the scope and spirit of the appended claims will occur to persons of ordinary skill in the art from a review of this disclosure.

We claim:

1. A method comprising:
stamping and forming a lead frame defining an opening and having an insulation displacement connector extending into the opening, wherein the insulation displacement connector has at least one blade which is configured to cut through an insulative covering which covers a conductor;
overmolding an insulative substrate onto a section of the insulation displacement connector without overmolding the at least one blade;
electrically and mechanically connecting an electrical component to the section of the insulation displacement connector; and
singulating the insulation displacement connector, the insulative substrate and the electrical component from the lead frame thereby forming an electrical connector.

2. The method as defined in claim 1, further comprising:
electrically attaching a conductor to the at least one blade of the insulation displacement connector, wherein the at least one blade of the insulation displacement connector cuts through an insulative covering which covers the conductor during the attachment.

3. The method as defined in claim 2, further comprising overmolding an insulative housing over the electrical connector and over a portion of the insulative covering.

4. The method as defined in claim 1, further comprising:
overmolding a first insulative housing over the electrical connector without overmolding the at least one blade of the insulation displacement connector, thereby forming an assembly;
inserting the assembly into a second insulative housing, wherein the at least one blade extends from the second insulative housing;
electrically attaching a conductor to the at least one blade of the insulation displacement connector, wherein the at least one blade of the insulation displacement connector cuts through an insulative covering which covers the conductor during the attachment; and
attaching an insulative cap to the second insulative housing.

5. The method as defined in claim 1, wherein the substrate has an opening provided therethrough which exposes a portion of the section of the insulation displacement connector thereby forming an exposed portion, and the electrical component is electrically connected to the exposed portion by forming a pattern on the insulative substrate, wherein the pattern extends along a surface of the insulative substrate and through the opening, and thereafter electroplating the pattern.

6. The method as defined in claim 4, further comprising:
electrically attaching a conductor to the at least one blade of the insulation displacement connector, wherein the at least one blade cuts through an insulative covering which covers the conductor during the attachment.

7. The method as defined in claim 6, further comprising overmolding an insulative housing over the electrical connector and over a portion of the insulative covering.

8. The method as defined in claim 1, wherein the insulative substrate has a projection, and further comprising electrically attaching a conductor to the at least one blade, wherein the conductor is severed by the projection into first and second wires prior to attachment.

9. The method as defined in claim 1, wherein the insulation displacement connector has a longitudinally extending section extending from the at least one blade, wherein the longitudinally extending section is angled at an angle relative to the at least one blade.

10. The method as defined in claim 9, wherein the substrate has an opening provided therethrough which exposes a portion of the section of the insulation displacement connector thereby forming an exposed portion, and the electrical component is electrically connected to the exposed portion by forming a pattern on the insulative substrate, wherein the pattern extends along a surface of the insulative substrate and through the opening, and thereafter electroplating the pattern.

11. An electrical connector comprising:
an insulative substrate;
an insulation displacement connector having a section partially encapsulated within the substrate and having at least one blade extending from the substrate, wherein the at least one blade is configured to cut through an insulative covering which covers a conductor;
a conductive trace electrically and mechanically coupled to the section of the insulation displacement connector; and
an electronic component electrically and mechanically coupled to the conductive trace, and
wherein the electrical connector is formed by an Application Specific Electronics Packaging (“ASEP”) manufacturing process comprising stamping and forming a lead frame defining an opening and having the insulation displacement connector extending into the opening, wherein the insulation displacement connector has at least one blade, overmolding an insulative substrate onto a section of the insulation displacement connector without overmolding the at least one blade, electrically connecting an electrical component to the section of the insulation displacement connector, and singulating the insulation displacement connector, the insulative substrate and the electrical component from the lead frame.

12. The electrical connector of claim 11, wherein the at least one blade is angled relative to the section.

13. The electrical connector of claim 11, wherein a plurality of the insulation displacement connectors are provided, a plurality of the conductive traces are provided, and the electronic component is electrically and mechanically coupled to the conductive traces.

14. An assembly comprising:
an electrical connector including:
an insulative substrate,
an insulation displacement connector having a section partially encapsulated within the substrate and having at least one blade extending from the substrate,
a conductive trace electrically and mechanically coupled to the section of the insulation displacement connector, and
an electronic component electrically and mechanically coupled to the conductive trace, and wherein the electrical connector is formed by an Application Specific Electronics Packaging (“ASEP”) manufacturing process wherein the electrical connector formed by an Application Specific Electronics Packaging (“ASEP”) manufacturing process comprising stamping and forming a lead frame defining an opening and having the insulation displacement connector extending into the opening, overmolding an insulative substrate onto a section of the insulation displacement connector without overmolding the at least one blade, electrically connecting an electrical component to the section of the insulation displacement connector, and singulating the insulation displacement connector, the insulative substrate and the electrical component from the lead frame; and
a conductor electrically coupled to the insulation displacement connector, wherein the at least one blade is configured to cut through an insulative covering which covers the conductor.

15. The assembly of claim 14, further comprising a second insulative housing overmolded over the electrical connector and over a portion of the insulative covering.

16. The assembly of claim 14, further comprising
an insulative housing generally encapsulating the electrical connector, wherein the housing does not encapsulate the at least one blade of the insulation displacement connector;
an insulative body having a slot, wherein the at least one blade of the insulation displacement connector is positioned within the slot; and
an insulative cap configured to be attached to the base.

17. The assembly of claim 16, wherein the conductor is part of a wire positioned between the body and the cap.

18. The assembly of claim 17, wherein the cap has a channel therethrough and the wire extends through the channel.

19. The assembly of claim 14, further comprising
an insulative housing generally encapsulating the electrical connector, wherein the housing does not encapsulate the at least one blade of the insulation displacement connector; and
an insulative body having a slot extending from an end thereof, and an opening in communication with the slot, wherein the at least one blade of the insulation displacement connector is seated within the slot and extends into the opening.

20. The assembly of claim 19, wherein the conductor is part of a wire positioned within the opening.
